(19) United States
(12) Patent Application Publication
(10) Pub. No.: US 2007/0283449 A1
(43) Pub. Date: Dec. 6, 2007

(54) Controlled content release system and method

(76) Inventors: Scott Blum, Jackson, WY (US); Andy Leak, Los Altos, CA (US); Geoff Schreiber, Portland, CA (US)

Correspondence Address: MITCHELL P. BROOK;C/O LUCE, FORWARD, HAMILTON & SCRIPPS LLP, 11988 EL CAMINO REAL, SUITE 200, SAN DIEGO, CA, 92130, US

(21) Appl. No.: 11/788,626

(22) Filed: Apr. 20, 2007

Related U.S. Application Data
(60) Provisional application No. 60/795,396, filed on Apr. 27, 2006.

(51) Int. Cl. H04N 7/169

(52) U.S. Cl. 726/28

(57) ABSTRACT

A content display system for displaying downloaded locked content that has associated launch parameters. The system includes a media player that includes a download module for downloading content from a content provider over a network, a storage module for storing the downloaded content in a cache memory and a launch module for determining whether the associated launch parameters have been met. The launch module unlocks the content if the launch parameters have been met so that the content may be accessed by a user.

### CROSS REFERENCE TO RELATED APPLICATION

Priority is claimed to Provisional Patent Application Ser. No. 60/795,396, filed Apr. 27, 2006, the contents of which are incorporated herein by reference.

### FIELD OF THE INVENTION

The present invention relates generally to a content display system and in particular a display system that includes a media player that provides controlled launch of content.

### BACKGROUND OF THE INVENTION

Marketing strategies of many media content suppliers, such as cable channels or movie distributors, rely upon controlled launch of content so that anticipation over the release may be elevated in the consuming public, and so that details of the content remain relatively confidential until a designated release time. For example, television content suppliers may spend marketing resources to publicize the launch of a season premier in an attempt to entice a wider audience. Movie content suppliers typically stagger release dates on different media, for example, one release date may be used for a theatrical release, another date for pay-per-view release of the same content, another release date for DVD or videotape release and another date for airlines or other distribution channels, all for the same content. One technique of controlling launch dates applicable to television distribution is via broadcast scheduling. However, other forms of distribution involve dissemination of a physical product, such as a DVD or film. Such regulation of content release suffers a deficiency of being less precise as some outlets may receive the physical item in advance of others.

Distribution of content over electronic communications networks, such as the Internet or via network connected mobile devices also are being pursued as potential outlets for content distribution. Various music and video players are available for providing Internet and mobile device users access to various forms of media. One example is the Windows Media Player available from Microsoft Corp. of Redmond, Wash. In operation, the Windows Media Player can be opened by various known alternatives, such as clicking on a toolbar icon, opening from a “Programs” menu from the Windows operating system “Start” area, or alternatively clicking on a desktop icon. Once opened, the Windows Media Player can be used to open and play videos or music files.

Other examples of conventional media players include Yahoo! Music Jukebox available from Yahoo! Inc. of Sunnyvale, Calif. and iTunes available from Apple Computer Inc. of Cupertino, Calif. By way of example, the Yahoo! Music Jukebox can be installed on a personal computer by loading the software, such as by downloading from the Musicmatch.com website. This software can be opened by the various known techniques, such as such as clicking on a toolbar icon, opening from a “Programs” menu, or clicking on a desktop icon. Once opened, the Yahoo! Music Jukebox appears in a separate window from the computer desktop, and separate from other program windows. It can be used to open and play music files on a personal computer, and to perform other music related functionalities such as downloading music, burning CDs, playing downloaded music, playing a “radio” or audio stream from a website server received via the internet, playing other streamed audio, playing tracks from a CD, managing a music file library, sending to a portable music player, managing a user's subscription account, obtaining information via the Internet on music, performers etc.

A problem with known media players is that oftentimes content files are so large that streaming is insufficient. Another problem is that high definition content requires a bandwidth higher than typically available for a viewer to stream. Providing content for download enables a user to view high definition content, however suffers a deficiency in that control of a future release date is diminished or lost. As a result, content having a controlled launch date typically is relatively low resolution rather than high definition resolution and or is provided after an initial release date such that the content is not released for download ahead of time.

Accordingly, there is a need for a system that providing content provider control of content release dates for content pre-loaded or pre-downloaded on a user device.

### SUMMARY OF THE INVENTION

The present invention alleviates to a great extent these and other disadvantages of known music or media players by providing a system and method in which content having a specific launch date is pre-loaded into a user device memory with release timing control parameters either provided within the content and/or provided in separate data files or scripting information, and thereby serve to control the playback of the content in accordance with the timing parameter(s) selected.

In one embodiment, the content display system includes a media player that is integrated an operating system of a user device. In another system the media player is separate from the operating system of the user device. In any event, the player modules are regulatable in accordance with timing parameters or data bits. In one embodiment, the system includes a download module, a storage module, a launch module (also referred to timing module) and a play module. Content is downloaded from or pushed by a content provider via the download module and stored via the storage module. Prior to allowing a user to access the content, the launch module determines if any launch parameters (also referred to as timing parameters, timing data etc.) associated with the content have been met. If they have, the content is played by the play module. Alternatively, the timing parameters can control the timing module to control the play module to operate and display the content in accordance with the timing parameters.

In an aspect of the present invention, content may be stored in a storage module either locally on the user's system or in a remote memory device that is available to the user device. The memory area available for storage of the content data is referred to herein as the “cache memory”. The cache memory may occupy the entirety of the available memory space of the storage module(s) or alternatively only a portion of the memory space available. Likewise the portion designated for the cache memory may fluctuate in size over time. In another aspect the content may be provided to the user's system by pulling or pushing operations.

These and other features and advantages of the present invention will be appreciated from review of the following detailed description of the invention, along with the accompanying figures in which like reference numerals refer to like parts throughout.

### BRIEF DESCRIPTION OF THE DRAWINGS

FIG. 1 is a schematic illustration showing a timeline of use of the content display system including controlled launch of content in accordance with the present invention;

FIG. 2 is a flowchart illustrating the method of using the content display system in accordance with the present invention;

FIG. 3 is a diagrammatic illustration of an Internet media content system in accordance with the present invention;

FIG. 4 is a block diagram illustrating an example of a user device in accordance with the present invention;

FIG. 5 is a graphical depiction of a user device memory in accordance with the present invention;

FIG. 6 is a graphical depiction of a user device memory in accordance with the present invention;

FIG. 7 is a flowchart illustrating an example of operation of a media player in a content display system in accordance with the present invention;

FIG. 8 is a flowchart illustrating another example of operation of a media player in a content display system in accordance with the present invention;

FIG. 9 is an illustration of a user interface and cache memory content menu in accordance with the present invention; and

FIG. 10 is a flowchart illustrating an example of operation of a content display system in accordance with the present invention.

### DETAILED DESCRIPTION OF THE INVENTION

In the following paragraphs, the present invention will be described in detail by way of example with reference to the accompanying drawings. Throughout this description, the preferred embodiments and examples shown should be considered as exemplars, rather than as limitations on the present invention. As used herein, the “present invention” refers to any one of the embodiments of the invention described herein, and any equivalents. Furthermore, reference to various aspects of the invention throughout this document does not mean that all claimed embodiments or methods must include the referenced aspects.

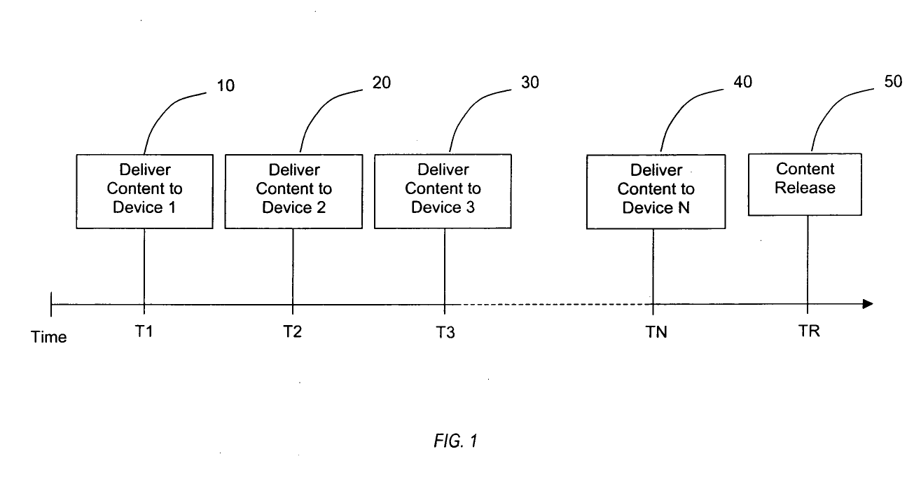

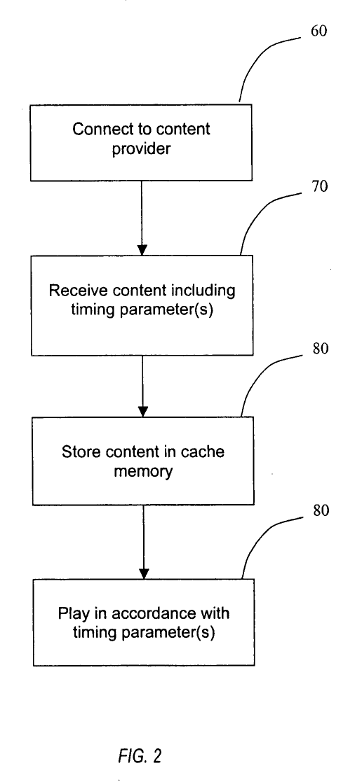

The present invention is directed to a system and method for widespread distribution of content, such as media content, to multiple remote devices that controls the release ofthat content on each of the devices. As shown in the timeline of FIG. 1, the system utilizes an entertainment or internet commerce system to allow a plurality of devices to download content 10, 20, 30, 40 at various times T1, T2, T3, TN prior to a content release 50 at a predetermined release date TR. As used herein “launch date” refers to a date and/or time determined by the content provider at which the content will be first available to the public. For example, for visual content, the launch date corresponds to the date and/or time that the content is available for viewing. It should be understood that a particular content item may have multiple timing or launch parameters associated with it. For example, a first period (such as a half hour or hour) of the content may be available at a first date, a second period of the content (such as a second half hour or hour) may be available at a second date (such as a week after the first date), a third period of the content (such as a third half hour or hour) may be available at a third date (such as a week after the second date), and so on.

The content may be made available to a user through a selected device by following the following general method illustrated in FIG. 1. in this method, content is supplied to the various devices, either simultaneously or at different times, as illustrated with reference numbers 10, 20, 30 and 40. Then the content is released at another time, as indicated with reference number 50. It should be understood that although the content release time (TR) is indicated as being after all the download times T1, T2 . . . . TN, it is possible that some devices may download the content after the timing parameter designated release time of TR. In this way, the content will remain available for optional delivery to a device in any desired time period, and viewing be set to initiate after a designated time or plural times in accordance with the release or timing parameters.

In one embodiment, a download module operates to receive content data via an electronic communications network, such as the Internet. In one example of a download module, connection module connects a device to a content provider as illustrated with reference number 60 such as via an electronic communications network such as the Internet. Next, a receiving module operates to receive the content, as illustrated with reference number 70. The content can be provided in a data file or stream by downloading, pushing or any other content delivery technique. One or more timing parameter(s) also are provided, either as a part of the content data, or separately packaged and delivered from it, as described in greater detail below. The content is stored in a storage module associated with the device, as illustrated with reference number 70. The storage module optionally containing memory portion devoted to storage of the content and/or other desired data, which is referred to as the cache memory. The play module plays the content in accordance with the timing parameter(s) 80. The playing can be done automatically, or upon an operation by the user of the device, such as by clicking on a play button or by operating a physical controller, such as on a personal content player, so long as the timing parameter is complied with. In one example, the play module includes a determination module, which determines if a launch date and/or time parameters has been met and provide access to the content after the launch date and/or time 90. The system and method are particularly advantageous because they allow content providers to provide users with large content files or high resolution content that otherwise could not be released via streaming or with a launch time parameter.

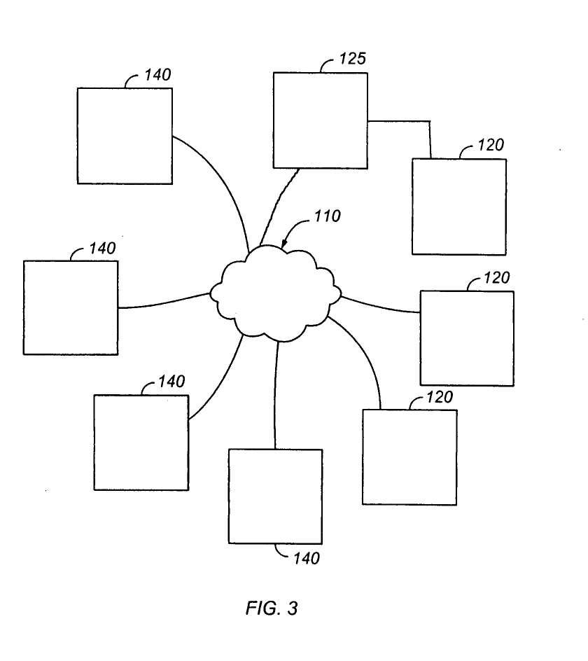

An exemplary entertainment or Internet commerce system is illustrated in FIG. 3, in which reference number 110 points to a representation of an electronic communications network (“ECN”), such as the Internet. Content providers are illustrated with reference number 120, which may be accessed by users such as through websites that can supply content to user devices 140. Alternatively, the content providers 120 can provide content to a content aggregator 125, which in turn provides the content to one or more user devices 140. The content providers 120 can provide the content either directly to the content aggregator via direct electronic connection or other form of data file transfer (such as master tapes), or via the electronic communications network 110. Content providers 120 may provide any desired content, including media content such as music data, video data, audiovisual data, information related thereto or any other type of data. Examples of content providers 120 are suppliers of music, television channels or movies for download. As used herein, “content” refers to any type of product or service available for purchase, license or rental, including without limitation music, movies, movie trailers, website content, digital books in visual or audio forms, and any other educational or entertainment data such as advertising. Similarly, “timing regulated content” is used herein to specifically denote content that has a specified launch date or other timing determinant.

Content providers 120 or content aggregators 125 can “push” content in the form of electronic or digital data to one or more specified user devices 140, either on a schedule or at other desired times. As used herein, it should be understood that where content is discusses as being supplied from a content provider 120 or a content aggregator 125, that it can be supplied in each instance from one or the other, or both. In one example, desired times may correspond to low bandwidth usage times, such as when the content provider is inactive or when there is more Internet bandwidth availability (often lower cost), such as in early morning hours. In another example, content may be pushed to the user devices 140 from one or more content provider 120 when user device 140 is logged on to a network and announces its presence to content provider 120. Alternatively, user device 140, or media player software of user device 140 may include an agent module that pulls or otherwise orders, initiates, requests or signals availability for delivery of content immediately or at any other time.

User systems 140 are capable of operating on the Internet, local networks or WANs so that content may be received (i.e. downloaded) and stored on user device 140 such as in its associated storage module. In addition, user devices 140 generally also function as a stand-alone unit so that downloaded content may be accessed when there is no network connection. As examples, user device 140 may include any computing devices, such as computers (such as PCs, laptops, notebooks, etc.), telephone handsets, cellular phones, personal data assistants (PDA), gaming systems, digital video recorders or any other device capable of storing content and providing the user access to the stored content such as personal media players.

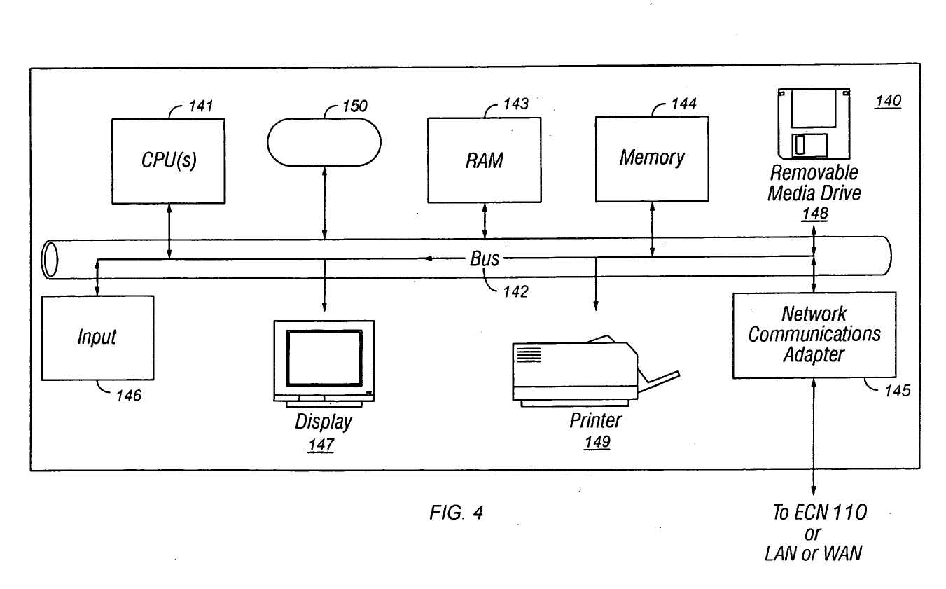

Referring to FIG. 4, an exemplary user device 140 is described. User device 140 includes a central processing unit 141 (“CPU”) connected through a bus 142 to volatile memory 143 (also called RAM or random access memory); non-volatile memory 144 (such as disk drive(s) or other magnetic or optical media, optical drive(s) or data tape(s)); a network communications adapter 145 (a telephone modem, DSL modem, cable modem, wireless modem, etc.); an input means 146, such as a keyboard and/or a pointing or point-and-click device (such as a mouse, light pen, touch screen, touch pad); an output device 147, such as a video display screen and/or an audio speaker or a port for connecting a video display or audio speaker; a removable media drive 148, such as a floppy disk drive, CD drive, DVD drive, PCMIA port, CD-WORM drive or data tape drive; and a printer 149. User device 140 also includes an operating system, which is generally software that allows the various components of user device 140 to communicate through bus 142 so that user device 140 may run program applications as is known in the art. It should be understood that the storage module and cache memory as discussed herein can reside in any one of or combination of RAM 143, Memory 144, Removable media 148, or even a remote or networked storage device, such as a networked hard drive, optical drive, thumb drive, memory card etc.

User device 140 also includes media player 150, which may be any form of software and or hardware. For example, media player 150 may be part of the operating system or a separate application. Although media player 150 is discussed herein primarily as a software component running on user device 140, it should be understood that a media player consistent with the present invention can include hardware components under control of software, or alternatively media player may include any number of computers, with components of the media player software residing in one or more of the computers. Media player software can reside in any or all of CPU 141, RAM 143, memory 144, removable media connected via removable media drive 148, or a server or memory device accessible via a local area network (“LAN”) or other network such as the ECN 110 via one or more network communications adapter 145. Media player 150 may be a single user application designed to run on a user device 140 or alternatively a networked application run on plural user devices 140.

Timing regulated content (such as content having a specific launch date and time or plural launch dates and times) is delivered to user device 140 from content provider 120 using media player 150. As mentioned above, the timing regulated content is preferably downloaded and stored prior to the desired release date onto user device 140. The content is downloaded to user device 140 such as via media player 150 and stored in storage module. As discussed herein, the preferred memory structure includes a cache memory portion (or entirety) of the storage module, which generally refers to any empty storage space that is available to user device 140 that may be used to store content, whether temporarily or permanently.

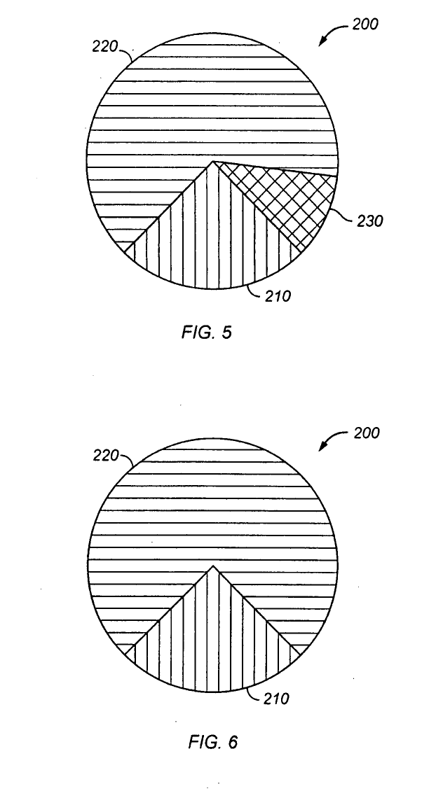

A graphical depiction of a generic storage module 200 that is available to user device 140 is provided in FIGS. 5 and 6. As discussed above this storage module can include a single storage device, or plural storage devices, whether local or networked. In the memory depicted in FIG. 5, the available memory space is partially occupied by the content files in the cache memory. In particular, application or data files other than content downloaded through media player 150 is depicted in region 210. These may be files that are pre-installed on user device 140, or are otherwise placed upon user device 140 such as by downloading from CD, DVD or the Internet. The cache memory is graphically depicted as region 220. The cache memory is filled with content downloaded onto user device 140 through media player 150. Additional unused memory area is depicted in region 230. It should be appreciated that the required capacity of cache memory depends on the size of the content downloaded. The downloaded content shown in FIG. 5, requires less memory than is available on memory 200 and as a result a portion 230 of memory 200 remains unused by media player 150. However, as depicted in FIG. 6 the entire unused portion of memory 200 may be required to store downloaded content. It should be further appreciated that cache memory may include all or portions of any number of available memory devices. It should further be appreciated that the size and location of the cache memory may change over time.

Cache memory 220 may be filled with any type of content desired, such as songs, movies, books, advertising, television channels, television programs, other entertainment etc. Cache memory 220 may optionally be invisible to the user of user device 140, or alternatively is visible. In other words, it may appear as empty hard drive space to the user, even though it contains content available via media player 150. In one embodiment, the cache memory 220 occupies all of the available memory space of the user device 140, in order to maximize the content available to the user on the user device 140. If the user desires to enter programs or other data into the memory of user device 140, the user can do so, and preferably is given priority so that some of the storage module space allocated to the data content cache memory is correspondingly reduced and depending on the usage state, the amount of content retained also may be reduced. If required, selection of content data in the cache memory to remove can be performed in any automatic or manual manner. For example, the process may be first in first out, predetermined hierarchy (e.g., songs first then movies; old songs first then old movies; or new songs first), detected user preferences, or specified user preferences etc. Alternatively, the content resident time within the storage module can be regulated in accordance with timing parameters, and be removed at a date or time set by timing data. For example, content provider 120 may provide content for a specific period of time as determined by the timing data. At the end of that period, or when a timing trigger is reached, all of the content may be replaced with new content provided for the next period, or alternatively specific content data can be deleted.

Timing regulated content is accessible if the associated timing criteria are met, as described in greater detail below. For example a portion of content may become available before other portions, may have a limited viewing window, or may become fully available, all depending on the timing parameters set. Likewise payment parameters can be set in a similar fashion.

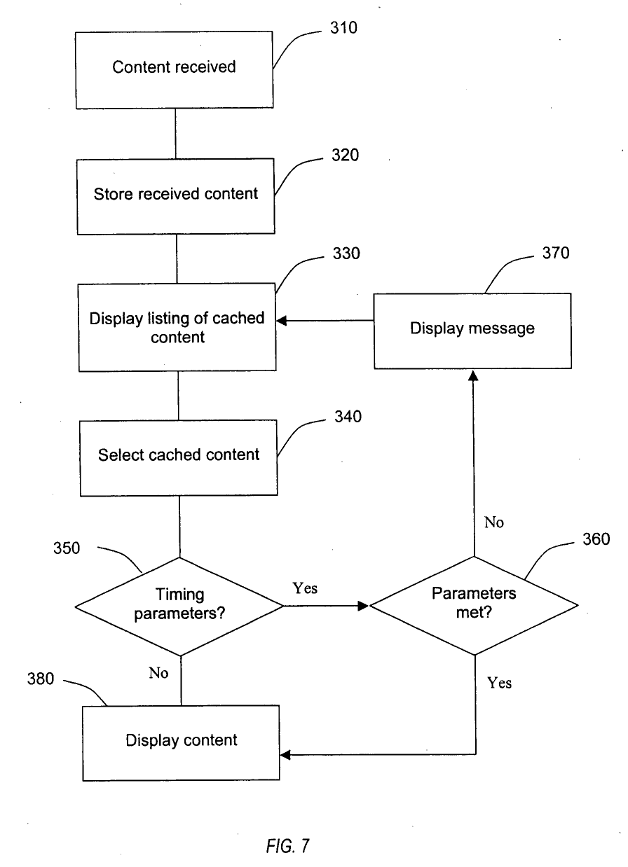

One example of operation of a time regulated content system is illustrated in FIG. 7. In step 310, content (any type of data file, preferably containing audio, video or audiovideo data) is received by user device 140. The content may be transferred to user device 140 in any manner such as manual downloading by the user, automatic pulling or pushing such as by media player 150, and/or pushing initiated from a remote system, such as for example content providers 120, content aggregators 125 and/or advertising servers.

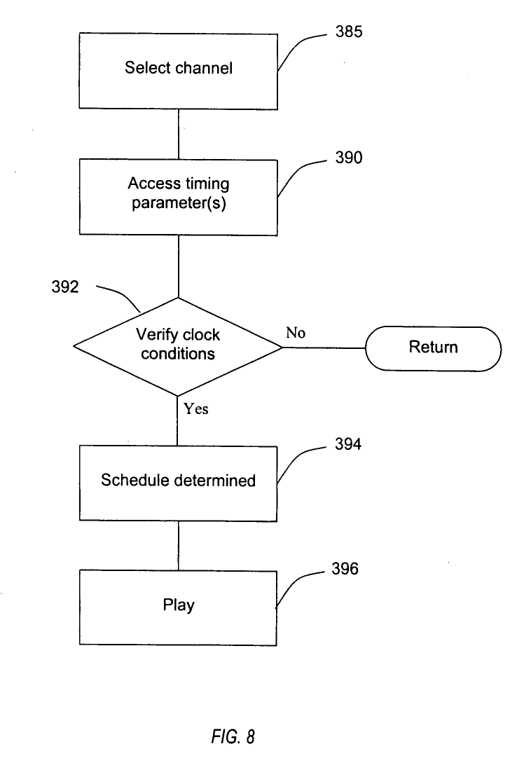

The content data received in user device 140 is stored in the cache memory of the storage module as illustrated in step 320. As described above, cache memory may include a combination of all or portions of various memory devices, including for example RAM 143, memory 144, removable media in drive 148 and/or networked memory. User device 140 may automatically designate cache memory or the user may designate a desired location in a local or a remote memory device for cache memory. In step 330 a listing of cached media is displayed on user device 140, such as on display 147. This may be accomplished by selecting a cache display option from a menu provided on a user interface screen of media player 150 as will be described with reference to FIG. 8 below.

The user then selects particular content (e.g., particular media file(s)), as illustrated in step 340. After selection, the timing module checks for associated timing or launch parameters in step 350. Timing or launch parameters may be included as part of the content or such parameters may be provided in a database, script file, look-up table or other form of schedule that is stored in user device 140 or accessed by user device in a remote location, such as at a content provider 120 or content aggregator 125. If the timing parameters are remotely stored, the remote timing parameters are checked in via this parameter check module.

If timing or launch module determines there are no launch parameters associated with the selected content, the content is played by media player 150, as shown in step 380. If, however, the timing module determines that the content is timing regulated content, the timing module determines if the timing parameters have been met in step 360, such as via an optional determination module that can be separate from or apart of the timing module 350, 360. Preferably media player 150 has an internal clock that is calibrated to a clock provided by content provider 120 when a network connection is made and the launch module of media player 150 compares the launch parameters to determine if they have been met (i.e., the release date and/or time has passed). Preferably, the time is also calibrated for the time zone of the particular user device 140. Alternatively, in order to prevent manipulation of the internal clock, the launch module can check an externally supplied clock, such as supplied by a content provider 120 or content aggregator 125 or other location accessible to the timing module. If the timing parameters have not been met, the device 140 preferably indicates to the user that the selection is not yet available, such as displaying a screen or window indicating that the selection has not yet been released and/or providing the launch date and/or time (step 370). The user optionally is returned to a listing of cached media of step 330. If the release date has passed or matches the current date and/or time, the timing regulated content is unlocked and media player 150 plays the content in step 380.

The launch module of media player 150 may alternatively determine if the launch date has been met prior to displaying the cached media in step 330. In such a method, content that has associated launch parameters that have not been met may be omitted from the displayed items. Alternatively, those items that have not yet been released may be indicated by some other indicator, such as an icon, coloration and/or shading. In addition, media player 150 may also be configured so that the content that is not yet available is displayed but may not be selectable by the user.

In one example, content is released on plural platforms simultaneously. For example, a movie can be released simultaneously on a cable television movie channel and on the user device 140. In this embodiment, the release times are coordinated by allowing pre-supply of high-definition content (i.e. HD) onto user systems 140 (as illustrated with reference number 310) and stored in the associated respective storage modules and cache memories (320). In this example, the user may subscribe to a movie service, which automatically pre-loads the content on to the user device 140. However the pre-supplied content is not viewable by the user until the timing or launch parameter is met. Once the timing or launch parameter is met, then the user can view it, or alternatively, it is automatically displayed. In this way media is launched at the same time across multiple platforms, and particularly via pre-storage on user devices 140. In another example, a set of television programs are released in accordance with a daily television program schedule. A user who wishes to view the television station, can view the pre-loaded content data in accordance with the schedule, as discussed in the embodiment illustrated in FIG. 8.

An alternative embodiment is illustrated in FIG. 8. In this alternative, the user device 140 accesses a checks a timing parameter database at a desired time, or upon selection of a viewing channel. The illustrated embodiment is of a television type of channel, although the system may otherwise access the timing parameters to determine whether a content file or files should be displayed. In the channel selection example, a user selects a desired channel via a channel selection module, as discussed more fully below, and as represented with reference number 385. For example, the user might select a movie channel, a general entertainment television channel, a sports channel, a news channel, a radio channel etc. The system then checks for timing parameters associated with the channel, as represented with reference number 390. Any form of timing data may be included in the timing parameter data. In one example, the timing data is stored in the storage module as discussed already, either locally or remotely. For example the timing parameters for a particular channel might be supplied via a content provider 120 or aggregator 125 as associated with that channel. Optionally, the device 140, such as via its media player 150 compares the timing parameters with a clock as described already to determine if a schedule can be created that does not violate a release time/date condition, as illustrated with reference number 392. The device 140, such as via its media player 150 then optionally determines a play schedule as indicated by reference number 394, and the content is displayed in accordance with the play schedule, as indicated with reference number 396. In one example, the timing parameters set start times and sequencing of various content data files or segments thereof. In one example, a television show is displayed, with a first part shown for 10 minutes, followed by 2 minutes of advertising content data (which optionally is interactive), followed by another 10 minutes of the television show, followed by one minute of advertising followed by five minutes of the show, followed by three minutes of advertising, followed by a second show, which optionally is shown with out advertising. In an alternative embodiment, the timing parameters provide launch times/dates for content already in the cache memory and once a “yes” indication is provide for a content file, the content file is modified to indicate availability.

An example of a cached content listing menu 402 created by a content listing module and included in a user interface 400 provided by media player 150 is depicted in FIG. 8, with identifiers (i.e. visual representation) of two content files 404 and 406, shown by way of example. It should be understood that any number of content files may be shown. In addition identifiers of cached content files can be located at any desired location such as in the cache memory area 407 of the storage module(s), Music 408, Videos 410, Playlists 412, or Library 414 locations illustrated in FIG. 8. The content files in the cache memory may be listed in one or more such locations as desired. In addition, Released and Unrealeased locations within the menu may also be provided that indicate media that is subject to launch parameters and whether those parameters have been met. Content files can be positioned in the various locations automatically by the storage module of media player 150 or manually by the user as desired by drag-and-drop or any other technique for positioning data identifiers. Furthermore, reminders, such as pop-ups, may be included that indicate when launch parameters for a content file have been met.

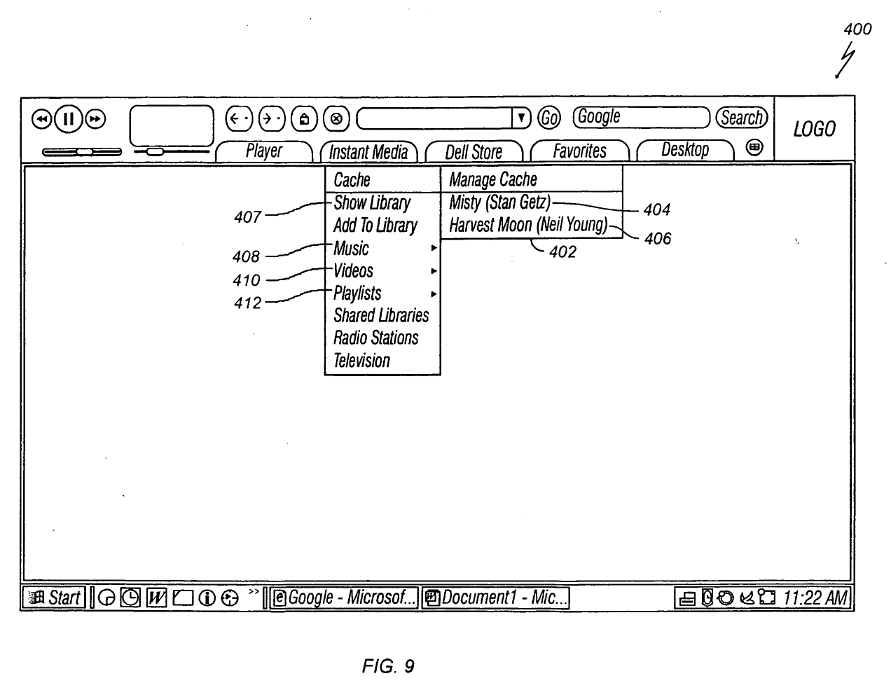

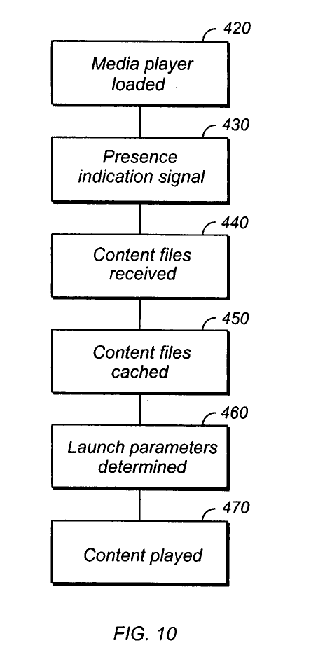

An example of loading files or data into the cache memory will be discussed from the point of view of a user device 140 as illustrated in FIG. 9. In step 420, the system is started, with media player 150 of the present invention operating. An Internet connection is established by media player 150 and a presence indication signal(s) optionally is sent from the user device 140 to one or more content providers 120 as indicated in step 430. Optionally this signal can include identifying information for the user, billing information, password information, and/or system status information. Alternatively, billing information or other information such as system status information, user demographic or prior usage information corresponding to a particular user can be pre-stored on user device 140 or by content provider 120. In one embodiment, the billing information (or other information) is keyed to a user identification that can become known from the identification signal, or alternatively is contained in the identification signal. The system status information may optionally include information on previous log ins, content viewed or otherwise accessed, memory space (for example disk space) utilized cache memory 220, or size of available memory space 230. After the presence indication signal is sent, media content to be sent to user device 140 is identified, and optionally a timing schedule or script particular to the user (or plural users) is created or identified for the user. For example, content providers 120 may determine free content files, pay content files and advertising or offer files to be provided to the user, along with the optional timing schedule or script for downloading. Optionally, the advertising content files are played when particular content files are selected by the user for playing.

As illustrated in step 440, the selected content files are received by a download module included in media player 150 of user device 140, from any desired source, preferably via the Internet 110. Optionally a play schedule or script for downloading is received by user device 140 first, and user device 140 acts in accordance with the schedule or script. For example, the script can designate times, content to download and locations where the content may be found. In other words, the script can include identifications of content files, location data indicating the Internet locations from which designated ones of the content files can be downloaded, downloading sequence for the one or more content files, download timing parameters and/or any other control instructions desired for user device 140. As used herein, “script” refers to a file or other form of data containing the desired information.

The received content is organized and stored in cache memory by a storage module of media player 150 of user device 140, as indicated by step 450. Next, the launch module of content player 150 determines any associated launch parameters and determines whether they are met. Finally, if all associated launch parameters are met, a play module of media player 150 plays the content on user device 140.

In an alternative embodiment, user device 140 may be purchased with pre-loaded content. Thus the new computer system may include any number of movies, music videos, commercials, songs and or website content that may or may not have launch parameters associated with them.

In another embodiment, user device 140 is left on at all times, or at relevant times, and a presence indication signal is not provided, or is periodically provided. In this alternative embodiment, content may be provided to user device 140 during any desired time periods.

Optionally, contextual discovery (or artificial intelligence programming) can be implemented for the media player to generate information, text, graphics, commercial offers, advertising or recommendations directly related to the currently playing media, or to media previously played.

Optionally, user device 140 generates the information, text, graphics, offers, advertising, recommendations, etc. based on information provided from the media player. In this option, the media player provides content provider 120 information about the currently (now) playing media or media previously played over any desired time period. The content provider uses this information in a software implemented process to make decisions and selections of data to send to the media player for processing and/or display. Examples of information generated can include artist biography, influencers, and contemporaries and genre information.

The media player optionally includes a media library function in which music, photos, movies and other media are managed, organized and/or displayed as discussed above. The library preferably is stored as a database either on the user's system 40 or on a system accessed via the Internet, where the user may store media content to be played or viewed in the media player application client. The user may search and sort the contents of the media library. For example display of the media library contents optionally is in accordance with the display of cache library as discussed above.

Download management and scheduling is a further optional function as discussed above. Users may use media player 150 to schedule downloads of media. Likewise the user can record streamed media, or video, such as television programs. Optionally, a download storage disk space limit is set in order to prevent overloading of memory modules available to the media player. A user also can select and review automatic downloads of recommended media as determined by preferences stored on or determined by media player 150 application or a server accessed via the Internet. Media player 150 may also provide storage on behalf of user system 140 for content that is pushed to it from servers over the Internet.

In one example, content provider 120 provides a subscription service for movies, television programs, radio programs and/or other audiovisual media. In this example, a cable-type of television service, movie subscription service or satellite-type of radio service is provided. For example a user can subscribe to a group of programming channels, or individual programming channels, programs or movie services or individual programs. Any number of channels, programs, services or other data transmissions can be selected, whether one, ten, hundreds or thousands etc. For instance in one example, a user subscribes to a cinema channel and on a periodic basis, such as a monthly basis, received a determined number of programs or movies. The movies (or other content) are loaded into cache memory 220 (or any other user-accessible memory) via the Internet. In a preferred embodiment, full-screen high-definition quality content is loaded into cache memory 220. Pre-loading in the memory in accordance with this invention, is particularly well-suited to full-screen high-definition programming, as opposed to streaming, under typically available bandwidth rates. The user can access the content located in the cache memory as desired and select (such as via clicking) programs or movies for viewing as desired. Subsequently when the viewing period is over, the content is deleted from cache memory 220, such as by using a memory management module, that also may be included in media player 150, which is adapted to deleting expired content from the cache memory. If the user's subscription is still active, new content for viewing during a particular period is preferably loaded into the cache memory prior to the beginning the period

It should be understood that the ordering of steps, module operation and connectivity discussed in this example and illustrated in the figures is just one possible iteration of the content channel embodiment. For instance, the system optionally provides options for playing to be started, stopped and otherwise manipulated as discussed herein in any way to provide a desired user viewing experience. Likewise, more than one content file can be played simultaneously if desired. For example, if there are multiple sporting events data stored in the cache memory, several may be displayed simultaneously. Alternatively, several programs can be displayed in an overlapping or cover over fashion.

In alternative embodiments, content is delivered a la carte, via subscription, or on a subject preferences basis. Likewise, advertising or promotional content can be delivered, in conjunction with the delivered programs, or as additional supplied content. For example, a subscriber to a movie channel might also receive a program guide associated with the movie channel providing descriptions of the content, director information, actor/actress information, ratings, etc.

Alternative embodiments include smart television that can be controlled in the same fashion as media player 150, i.e. creation of a control script executed by the television for the display of content and advertising. Launch parameters may be included in the television content that prevents the content from being shown prior to a scheduled release date and/or time. Likewise a computer type system can be used, which utilizes a television for a display. Additional embodiments include smart billboards or signage, in which control scripts are created for particularly selected billboards, and media content and advertising displayed thereon. Yet another embodiment is signage at ballparks in which a scoreboard or advertising display plays content and advertising. Another application is portable music or other portable display device having either wireless or wired Internet connections. Alternatively a portable device having only a wired Internet connection can be synched by connecting it to the Internet such as via a USB cable (or other wired connection) to an Internet appliance such as a smart TV, PC or TIVO, and then is synched by announcing its presence to the server, receiving a script and downloading designated content.

Thus, it is seen that a media player and operating system are provided that protect specified launch dates for content downloaded on a user device. One skilled in the art will appreciate that the present invention can be practiced by other than the preferred embodiments which are presented in this description for purposes of illustration and not of limitation, and the present invention is limited only by the claims that follow. It is noted that equivalents for the particular embodiments discussed in this description may practice the invention as well.

What is claimed is:

1. A media player, comprising:
a download module configured to control downloading of content from a remote source;
a storage module within which the downloaded content is stored; and
a timing module configured to determine a timing parameter associated with at least a portion of the content.

2. The media player of claim 1 wherein the timing module includes a determination module comparing the timing parameter with a clock.

3. The media player of claim 1 wherein the timing module releases the content for viewing if its associated timing parameter has been complied with.

4. The media player of claim 1 wherein the storage module includes a designated cache memory portion within which said content data is stored.

5. The media player of claim 1 further comprising a content listing module configured to provide selectable indicators of the downloaded content.

6. The media player of claim 5 wherein the content listing module is configured to indicate locked and unlocked content.

7. The media player of claim 6 wherein the content listing module is configured to indicate locked and unlocked content using at least one of icons, coloration and shading.

8. The media player of claim 1 further comprising a play module configured to provide display data of content for which a timing parameter has been met.

9. The media player of claim 1 wherein the launch parameters include a date and a time.

10. The media player of claim 1 wherein the launch parameter data is included in the downloaded content data.

11. The media player of claim 1 further comprising an internal clock, wherein the launch module is configured to compare a launch date included in the launch parameters with the time indicated by the internal clock.

12. The media player of claim 1 wherein the launch module is configured to compare a launch date included in the launch parameters with the time indicated by an external clock.

13. A content display system, comprising:
a central processing unit;
a memory device in data communication with the central processing unit and configured to store data;
a network communication device configured to provide data communication with a content provider through a network;
an output device; and
a media player in data communication with the central processing unit, the media player including a download module configured to control downloading of locked content having associated launch parameters from a remote source into local a data memory, a storage module configured to organize the downloaded content in a cache memory, a launch module configured to unlock the content upon making a determination that the launch parameters have been met and a play module configured to send unlocked content data to the display device.

14. The content display system of claim 13 wherein the output device is at least one of a computer monitor, a television monitor and an audio speaker.

15. The content display system of claim 14 wherein the memory device is at least one of random access memory, a hard disk, a removable media device and a network server.

16. The content display system of claim 15 wherein the media player includes a content listing module configured to indicate locked and unlocked content.

17. The content display system of claim 16 wherein the content listing module is configured to indicate locked and unlocked content using at least one of icons, coloration and shading.

18. A method of displaying content, comprising the steps of:
downloading locked content including associated launch parameters from a content provider;
storing the downloaded content in a cache memory;
retrieving the downloaded content from the cache memory;
determining whether the associated launch parameters have been met.

19. The method of displaying content of claim 18, further comprising the step of unlocking the downloaded content upon a determination that the associated launch parameters have been met.

20. The method of displaying content of claim 18, further comprising the step of providing a message indicating that the content is not available upon a determination that the associated launch parameters have not been met.

21. The method of displaying content of claim 18, further comprising the step of providing a list of downloaded content.

22. The method of displaying content of claim 21 wherein the list is provided after the step of determining whether the associated launch parameters have been met.

23. The method of displaying content of claim 22, wherein the list includes the downloaded content for which the associated launch parameters have been met.

24. The method of displaying content of claim 18, further comprising the step of displaying unlocked content on a display device.

25. A method of displaying content, comprising the steps of:
storing content supplied from a content provider;
selecting a channel for viewing wherein at least a portion of said content data is associated with the channel;
reading timing parameter data;
determining a display schedule in accordance with the timing parameter data and clock data; and
playing at least a portion of the content data in accordance with the display schedule.
